(19) United States
(12) Patent Application Publication
(10) Pub. No.: US 2021/0122258 A1
(43) Pub. Date: Apr. 29, 2021

(54) EV CHARGING STATION

(71) Applicant: Wellen Sham, Taipei City (TW)

(72) Inventor: Wellen Sham, Taipei City (TW)

(21) Appl. No.: 16/664,968

(22) Filed: Oct. 28, 2019

(51) Int. Cl. B60L 53/63; H02J 7/35; H02J 7/02; H02J 7/00; H02J 13/00; B60L 53/51; B60L 53/53; B60L 53/62

(52) U.S. Cl. CPC B60L 53/63; H02J 7/355; H02J 7/02; H02J 7/0021; B60L 53/16; H02J 13/0006; B60L 53/51; B60L 53/53; B60L 53/62; H02J 7/027

(57) ABSTRACT

Provided is an EV charging station comprising a housing, one storage battery, a substantially flat panel, an array of photovoltaic modules and a control unit. The housing receives electric power from a power grid. The substantially flat panel is attached to the housing. The array of photovoltaic modules are affixed to the flat panel and converts solar energy from sun light into electrical energy, and transfer the electrical energy to the storage battery in the housing. The control unit receives a first signal indicating the power grid is overloaded and not available to the EV charging station; in response to receiving the first signal, determining whether the storage battery is charged; and in response to the determination that the storage battery is charged, switching the EV charging station to a charge mode where the storage battery is used, instead of the power grid, to charge an EV.

### BACKGROUND OF THE INVENTION

This invention relates generally to EV charging station and method.

An electric vehicle charging station, also called EV charging station, electric recharging point, charging point, or charge point and EVSE (electric vehicle supply equipment), is an element in an infrastructure that supplies electric energy for the recharging of electric vehicles, such as plug-in electric vehicles, including electric cars, neighborhood electric vehicles and plug-in hybrids. As electric vehicles and battery electric vehicle ownership is expanding, there is a growing need for widely distributed publicly accessible charging stations, some of which support faster charging at higher voltages and currents than are available from residential EVSEs. Many charging stations are on-street facilities provided by electric utility companies or located at retail shopping centers and operated by many private companies.

To refuel a conventional liquid or gas powered vehicle takes a matter of minutes, an electric vehicle however may take hours depending upon the battery type and charger specifications. In addition to the long time taken to re-fuel, there is an even simpler problem that is inherent to electric vehicles, to recharge they need a stable electrical supply. In some suburb places and countryside, local facility still cannot guarantee stable electricity supply. Thus an EV charging station with reusable power supply is needed for charging EVs.

### BRIEF SUMMARY OF THE INVENTION

Provided is an EV charging station comprising a housing, at least one storage battery, a substantially flat panel, an array of photovoltaic modules and a control unit. The housing receives electric power from a power grid. The array of photovoltaic modules are affixed to the flat panel and are configured to convert solar energy from sun light into electrical energy, and transfer the electrical energy from the photovoltaic modules to the storage battery in the housing. The control unit is configured to receive a signal indicating the power grid is overloaded and not available to the EV charging station; in response to receiving the signal, determining whether the storage battery is charged; in response to the determination that storage battery is charged and to the signal having been received, switching the EV charging station to a charge mode where the storage battery is used, instead of the power grid, to charge an EV.

This summary is not intended to identify key or essential features of the claimed subject matter, nor is it intended to be used in isolation to determine the scope of the claimed subject matter. The subject matter should be understood by reference to appropriate portions of the entire specification of this patent, any or all drawings, and each claim.

### BRIEF DESCRIPTION OF THE DRAWINGS

FIG. 1 generally illustrates an EV charging station in accordance with the disclosure.

FIG. 2 illustrates one exemplary battery energy storage system (BESS) in accordance with the disclosure.

FIG. 3 illustrates one exemplary EV charging method in accordance with the disclosure.

FIG. 4 illustrates a simplified computer system, according to an exemplary embodiment of the present disclosure.

### DETAILED DESCRIPTION OF THE INVENTION

In accordance with the disclosure, embodiments can provide an EV charging station and method. Various specific embodiments of the present disclosure will be described below with reference to the accompanying drawings constituting a part of this specification. It should be understood that, although structural parts and components of various examples of the present disclosure are described by using terms expressing directions, e.g., “front”, “back”, “upper”, “lower”, “left”, “right” and the like in the present disclosure, these terms are merely used for the purpose of convenient description and are determined on the basis of exemplary directions displayed in the accompanying drawings. Since the embodiments disclosed by the present disclosure may be set according to different directions, these terms expressing directions are merely used for describing rather than limiting. Under possible conditions, identical or similar reference numbers used in the present disclosure indicate identical components.

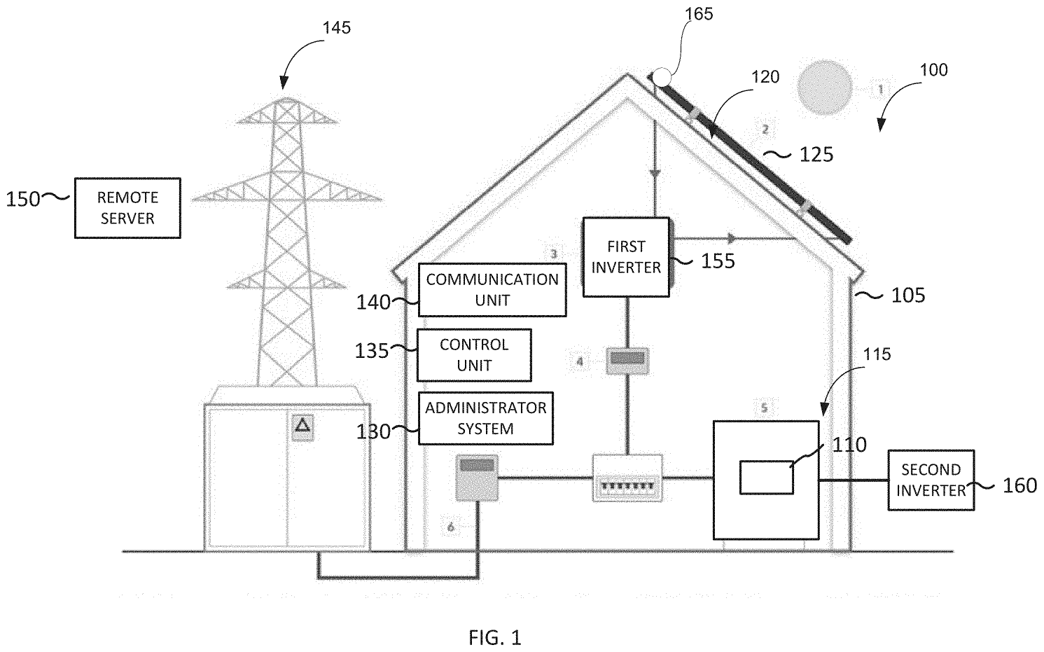

Various exemplary embodiments are directed to an EV charging station 100 to charge electric vehicle. As shown in the example of FIG. 1, charging station 100 may include: housing 105, battery energy storage system (BESS) 115, storage battery 110, flat panel 120, photovoltaic module 125, administrator system 130, control unit 135, communication unit 140, power grid 145, remote server 150, first inverter 155, second inverter 160, and light intensity sensor 165.

Charging station 100 may be utilized for personal and commercial electric vehicle. Charging station 100 may be placed in designated areas on public streets and on private or city land, such as garages and warehouses used to park or store personal and commercial electric vehicle. Though charging station 100 may be placed anywhere, placement may be optimized to support and promote electric charging in specific zones. Charging station 100 may also be effective, for example for commercial vehicle, in designated loading zones.

The housing 105 may contain various electronic and mechanical components associated with the charging station 100. For example, battery energy storage system (BESS) 115, storage battery 110, flat panel 120, photovoltaic module 125, administrator system 130, control unit 135, and communication unit 140 may be positioned in the housing 105.

The photovoltaic modules 125 are affixed to the flat panel and are configured to convert solar energy from sun light into electrical energy, and transfer the electrical energy from the photovoltaic modules to the storage battery in the housing. In addition to the photovoltaic modules 125, a photovoltaic system consists of an arrangement of several other components, including a solar inverter to change the electric current from DC to AC, as well as mounting, cabling and other electrical accessories, such as rectifiers and various control units.

In some embodiments, the array of photovoltaic modules is configured to produce a direct current output. The EV charging station further comprises a second inverter 160 electrically interconnecting the storage battery with the EV to convert direct current from the storage battery into alternating current at the EV.

In some embodiments, the array of photovoltaic modules is configured to produce an alternating current output. The EV charging station further comprises a first inverter 155 electrically interconnecting the array of photovoltaic modules with the storage battery to convert alternating current from the array of photovoltaic modules into direct current at the storage battery.

The photovoltaic module 125 may include various configurations having different sizes, orientations, and made from different materials for transmitting solar power to electricity. The photovoltaic module 125 is electrically connected to a storage battery 110 which may include one or more rechargeable batteries and a battery management system. The photovoltaic module 125 is capable of charging the batteries.

The administrator system 130 may be capable of performing various tasks and operations such as monitoring, management, customer service and support, and/or scheduling. The administrator system 130 may be capable of controlling, monitoring, testing or calibrating the components in the charging station 100. The administrator system 130 may also be capable of sending alerts to users, authorities, and other relevant parties, for example police, fire, medical services, or towing services.

The control unit 135 is configured to receive a signal indicating the power grid is overloaded and not available to the EV charging station; in response to receiving the signal, determining whether the storage battery is charged; in response to the determination that storage battery is charged and to the signal having been received, switching the EV charging station to a charge mode where the storage battery is used, instead of the power grid, to charge an EV. In some embodiments, the control unit is further configured to, in response to receiving the first signal, determining whether a charge percentage of the storage battery is beyond a preset value; and in response to the determination that the charge percentage of the storage battery is beyond the preset value and to the first signal having been received, switching the EV charging station to the charge mode where the storage battery is used, instead of the power grid, to charge the EV. The preset value may be during the range of 20%-100%. The preset value may be set manually by operator of the EV charging station or automatically by the administrator system according to various factors, such as total power capacity of the storage batteries, average quantity of EVs charged daily, etc.

In some embodiments, the storage battery is configured to be charged by the power grid. In some embodiments, the control unit is further configured to receive a second signal indicating a charge percentage of the storage battery; receive a light intensity value of the sun light; and in response to receiving the second signal and the light intensity value, determining energy source to charge the storage battery, wherein the energy source is at least one of the power grid or the sun light.

The control unit 135 may include various electronic, mechanical, and/or electromechanical components to perform various control, analytical, and communication functions such as those described herein. The control unit 135 may include one or more microcontrollers, such as an Arduino board to perform dedicated tasks and functions. Though the control unit 135 is depicted and described as a single unit for clarity, it may be comprised of several individual units, working together or in isolation, to perform the various functions described herein.

The control unit 135 may be connected to a power grid, for example an electrical utility line. The control unit 135 may contain various electronic components to convert or modify the power received from the power grid and supply the storage battery 110 with power in an appropriate amount, having the correct current and frequency. The control unit 135 is capable of selectively powering the storage battery 110 at appropriate times, such as by activating the storage battery 110 when a vehicle is detected or a request for charging is received, or by deactivating the storage battery 110 when a vehicle leaves.

The control unit 135 is configured to communicate with the power grid and the storage battery. The control unit 135 may contain, or be connected to, a communication unit 140 to receive and transmit information from various sources. The communication unit 140 may receive and transmit information through a wired connection and/or wirelessly. Wired connections may be achieved through one or more data or network ports. Wireless communication may be achieved through radio frequency, Bluetooth, or WiFi wireless transmission as well as optic, infrared, or other light signaling. The communication unit 140 may be in communication, either through a data connection or an electrical connection to receive and transmit information for other components in the charging station 100. The communication unit may also communicate with devices and locations outside of the charging station 100. The control unit 135 and the communication unit 140 may incorporate a beagleboard or beaglebone type device to provide computing and communication functionality.

In various exemplary embodiments, the communication unit 140 transmits and receives information to and from various external devices such as the battery management system, the sensors, and one or more mobile devices. Mobile devices may include any mobile electronic device, such as a mobile phone, tablet, laptop or other computing device. The mobile device may also be a vehicle related device, such as a global positioning device (GPS), dashboard or other onboard, vehicle computer. A vehicle related mobile device may be a dedicated unit or integrated with the vehicle to perform different functions. The mobile device may be capable of receiving information related to the vehicle, for example position, battery level, and charging rate. Accordingly, the battery management system may also be able to communicate directly with one or more mobile devices.

The communication unit 140 may also be capable of transmitting and receiving information to and from a remote server 150. The remote server 150 may include a dedicated server or a storage network, such as a cloud computing network. The communication unit 140 transmits information to the remote server 150 via the Internet or a dedicated network, either through a hardwired connection or wireless connection as discussed above. In various exemplary embodiments, the sensors communicate with the remote server 150 directly or through the communication unit 140. Information sent to the remote server 150 may include operating status, occupancy status, charging efficiency and statics, sensor data, and usage data. The remote server 150 may also communicate with the mobile device and other devices, such as an additional user device as well as an administrator system 130. The user device may include any user computing device such as a mobile device described above or a stationary computer or terminal.

In various exemplary embodiments, the remoter server 165 may be designed to interact with one or more databases for storing information relating to different charging station 100, different vehicle, and/or different users. The remoter server 165 may implement a database management system for storing, compiling, and organizing data, and to allow a user and administrators to access and search the stored data. The databases may contain different units for storing data related to different topics, for example charging station 100 information, user account information, and vehicle information.

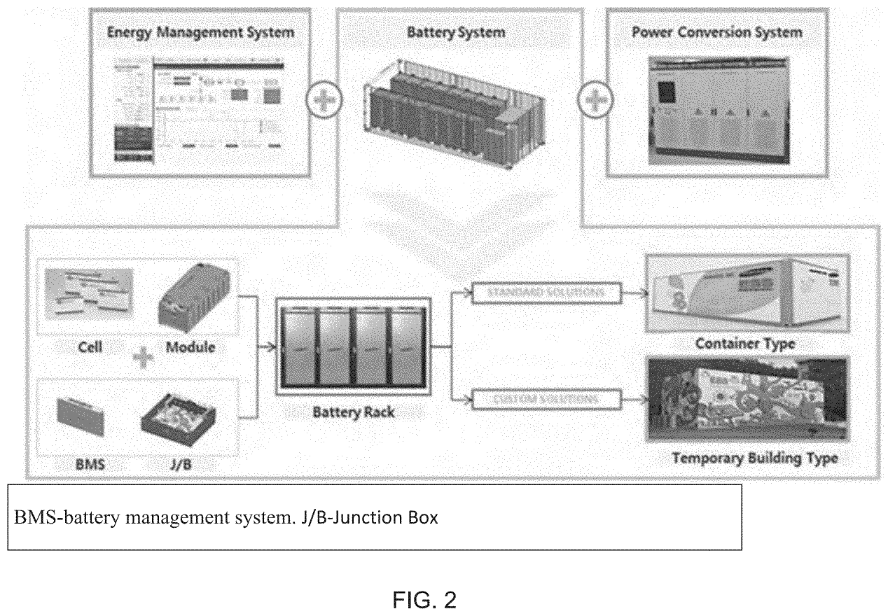

FIG. 2 illustrates one exemplary battery energy storage system (BESS) 115 in accordance with the disclosure. BESS components are grouped according to function into battery components, components required for reliable system operation, and grid connection components.

The battery system 115 consists of the storage battery pack 110, which connects multiple cells to appropriate voltage and capacity; the battery management system (BMS); and the battery thermal management system (B-TMS). The storage battery 110 may be capable of fast charging at higher voltages and currents. The BMS protects the cells from harmful operation, in terms of voltage, temperature, and current, to achieve reliable and safe operation, and balances varying cell states-of-charge (SOCs) within a serial connection. In an exemplary embodiment, the BMS is capable of monitoring one or more properties of the batteries, for example charge level, charging rate, temperature, and usage efficiency. The B-TMS controls the temperature of the cells according to their specifications in terms of absolute values and temperature gradients within the pack.

The components required for the reliable operation of the overall system are system control and monitoring, the energy management system (EMS), and system thermal management. System control and monitoring is general (IT) monitoring, which is partly combined into the overall supervisory control and data acquisition (SCADA) system but may also include fire protection or alarm units. The EMS is responsible for system power flow control, management, and distribution. System thermal management controls all functions related to the heating, ventilation, and air-conditioning of the containment system. The power electronics can be grouped into the conversion unit, which converts the power flow between the grid and the battery, and the required control and monitoring components—voltage sensing units and thermal management of power electronics components (fan cooling).

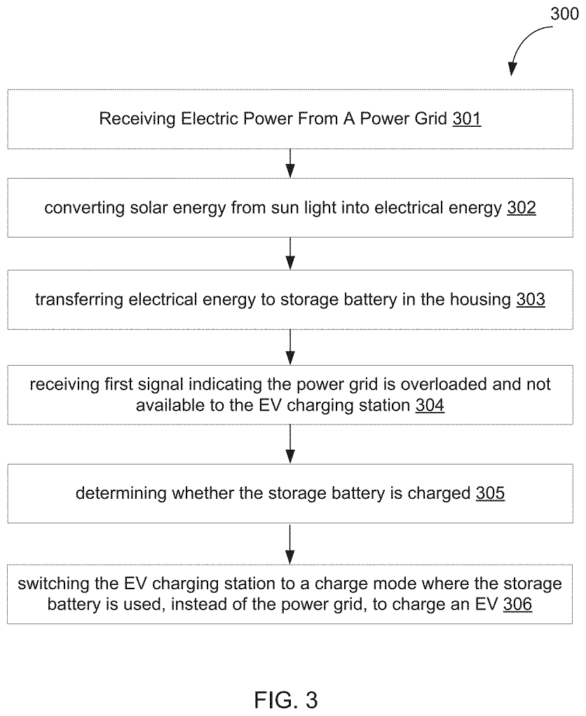

FIG. 3 illustrates one exemplary EV charging method in accordance with the disclosure. The operations of method 300 presented below are intended to be illustrative. In some embodiments, method 300 may be accomplished with one or more additional operations not described and/or without one or more of the operations discussed. Additionally, the order in which the operations of method 300 are illustrated in FIG. 3 and described below is not intended to be limiting.

In some embodiments, method 300 may be implemented in one or more processing devices (e.g., a digital processor, an analog processor, a digital circuit designed to process information, an analog circuit designed to process information, a state machine, and/or other mechanisms for electronically processing information). The one or more processing devices may include one or more devices executing some or all of the operations of method 300 in response to instructions stored electronically on an electronic storage medium. The one or more processing devices may include one or more devices configured through hardware, firmware, and/or software to be specifically designed for execution of one or more of the operations of method 300.

At 301, the method 300 includes receiving electric power from a power grid. In some implementations, operation 301 can be performed by a housing substantially similar to or the same as the housing 105 as described and illustrated herein.

At 302, the method 300 includes converting, by an array of photovoltaic modules affixed to a substantially flat panel attached to the housing, solar energy from sun light into electrical energy. In some implementations, operation 302 can be performed by a laser substantially similar to or the same as the photovoltaic module 125 as described and illustrated herein.

At 303, the method 300 includes transferring, by the array of photovoltaic modules, the electrical energy to a storage battery in the housing. In some implementations, operation 303 can be performed by a laser substantially similar to or the same as the photovoltaic module 125 as described and illustrated herein.

At 304, the method 300 includes receiving, by a control unit in the housing, a first signal indicating the power grid is overloaded and not available to the EV charging station. In some implementations, operation 304 can be performed by a control unit substantially similar to or the same as the control unit 135 as described and illustrated herein.

At 305, the method 300 includes in response to receiving the first signal, determining whether the storage battery is charged. In some implementations, operation 305 can be performed by a control unit substantially similar to or the same as the control unit 135 as described and illustrated herein.

At 306, the method 300 includes in response to the determination that the storage battery is charged and to the first signal having been received, switching the EV charging station to a charge mode where the storage battery is used, instead of the power grid, to charge an EV. In some implementations, operation 306 can be performed by a control unit substantially similar to or the same as the control unit 135 as described and illustrated herein.

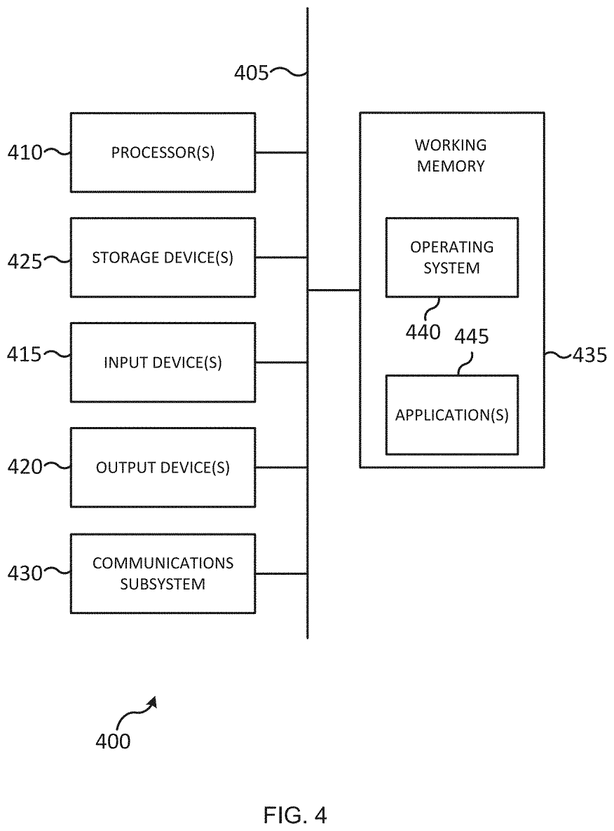

FIG. 4 illustrates a simplified computer system that can be used implement various embodiments described and illustrated herein. A computer system 400 as illustrated in FIG. 4 may be incorporated into devices such as a portable electronic device, mobile phone, or other device as described herein. FIG. 4 provides a schematic illustration of one embodiment of a computer system 400 that can perform some or all of the system provided by various embodiments. It should be noted that FIG. 4 is meant only to provide a generalized illustration of various components, any or all of which may be utilized as appropriate. FIG. 4, therefore, broadly illustrates how individual system elements may be implemented in a relatively separated or relatively more integrated manner.

The computer system 400 is shown comprising hardware elements that can be electrically coupled via a bus 405, or may otherwise be in communication, as appropriate. The hardware elements may include one or more processors 410, including without limitation one or more general-purpose processors and/or one or more special-purpose processors such as digital signal processing chips, graphics acceleration processors, and/or the like; one or more input devices 415, which can include without limitation a mouse, a keyboard, a camera, and/or the like; and one or more output devices 420, which can include without limitation a display device, a printer, and/or the like.

The computer system 400 may further include and/or be in communication with one or more non-transitory storage devices 4150, which can comprise, without limitation, local and/or network accessible storage, and/or can include, without limitation, a disk drive, a drive array, an optical storage device, a solid-state storage device, such as a random access memory (“RAM”), and/or a read-only memory (“ROM”), which can be programmable, flash-updateable, and/or the like. Such storage devices may be configured to implement any appropriate data stores, including without limitation, various file systems, database structures, and/or the like.

The computer system 400 might also include a communications subsystem 430, which can include without limitation a modem, a network card (wireless or wired), an infrared communication device, a wireless communication device, and/or a chipset such as a Bluetooth™ device, an 1002.11 device, a WiFi device, a WiMax device, cellular communication facilities, etc., and/or the like. The communications subsystem 430 may include one or more input and/or output communication interfaces to permit data to be exchanged with a network such as the network described below to name one example, other computer systems, television, and/or any other devices described herein. Depending on the desired functionality and/or other implementation concerns, a portable electronic device or similar device may communicate image and/or other information via the communications subsystem 430. In other embodiments, a portable electronic device, e.g. the first electronic device, may be incorporated into the computer system 400, e.g., an electronic device as an input device 415. In some embodiments, the computer system 400 will further comprise a working memory 435, which can include a RAM or ROM device, as described above.

The computer system 400 also can include software elements, shown as being currently located within the working memory 435, including an operating system 440, device drivers, executable libraries, and/or other code, such as one or more application programs 445, which may comprise computer programs provided by various embodiments, and/or configure systems, provided by other embodiments, as described herein. Merely by way of example, one or more procedures described with respect to the system discussed above, such as those described in relation to FIG. 4, might be implemented as code and/or instructions executable by a computer and/or a processor within a computer; in an aspect, then, such code and/or instructions can be used to configure and/or adapt a general purpose computer or other device to perform one or more operations in accordance with the described system.

A set of these instructions and/or code may be stored on a non-transitory computer-readable storage medium, such as the storage device(s) 4150 described above. In some cases, the storage medium might be incorporated within a computer system, such as computer system 400. In other embodiments, the storage medium might be separate from a computer system e.g., a removable medium, such as a compact disc, and/or provided in an installation package, such that the storage medium can be used to program, configure, and/or adapt a general purpose computer with the instructions/code stored thereon. These instructions might take the form of executable code, which is executable by the computer system 400 and/or might take the form of source and/or installable code, which, upon compilation and/or installation on the computer system 400 e.g., using any of a variety of generally available compilers, installation programs, compression/decompression utilities, etc., then takes the form of executable code.

It will be apparent to those skilled in the art that substantial variations may be made in accordance with specific requirements. For example, customized hardware might also be used, and/or particular elements might be implemented in hardware, software including portable software, such as applets, etc., or both. Further, connection to other computing devices such as network input/output devices may be employed.

As mentioned above, in one aspect, some embodiments may employ a computer system such as the computer system 400 to perform system in accordance with various embodiments of the technology. According to a set of embodiments, some or all of the procedures of such methods are performed by the computer system 400 in response to processor 410 executing one or more sequences of one or more instructions, which might be incorporated into the operating system 440 and/or other code, such as an application program 445, contained in the working memory 435. Such instructions may be read into the working memory 435 from another computer-readable medium, such as one or more of the storage device(s) 4150. Merely by way of example, execution of the sequences of instructions contained in the working memory 435 might cause the processor(s) 410 to perform one or more procedures of the methods described herein. Additionally or alternatively, portions of the methods described herein may be executed through specialized hardware.

The terms “machine-readable medium” and “computer-readable medium,” as used herein, refer to any medium that participates in providing data that causes a machine to operate in a specific fashion. In an embodiment implemented using the computer system 400, various computer-readable media might be involved in providing instructions/code to processor(s) 410 for execution and/or might be used to store and/or carry such instructions/code. In many embodiments, a computer-readable medium is a physical and/or tangible storage medium. Such a medium may take the form of a non-volatile media or volatile media. Non-volatile media include, for example, optical and/or magnetic disks, such as the storage device(s) 4150. Volatile media include, without limitation, dynamic memory, such as the working memory 435.

Common forms of physical and/or tangible computer-readable media include, for example, a floppy disk, a flexible disk, hard disk, magnetic tape, or any other magnetic medium, a CD-ROM, any other optical medium, punchcards, papertape, any other physical medium with patterns of holes, a RAM, a PROM, EPROM, a FLASH-EPROM, any other memory chip or cartridge, or any other medium from which a computer can read instructions and/or code.

Various forms of computer-readable media may be involved in carrying one or more sequences of one or more instructions to the processor(s) 410 for execution. Merely by way of example, the instructions may initially be carried on a magnetic disk and/or optical disc of a remote computer. A remote computer might load the instructions into its dynamic memory and send the instructions as signals over a transmission medium to be received and/or executed by the computer system 400.

The communications subsystem 430 and/or components thereof generally will receive signals, and the bus 405 then might carry the signals and/or the data, instructions, etc. carried by the signals to the working memory 435, from which the processor(s) 410 retrieves and executes the instructions. The instructions received by the working memory 435 may optionally be stored on a non-transitory storage device 4150 either before or after execution by the processor(s) 410.

The methods, systems, and devices discussed above are examples. Various configurations may omit, substitute, or add various procedures or components as appropriate. For instance, in alternative configurations, the methods may be performed in an order different from that described, and/or various stages may be added, omitted, and/or combined. Also, features described with respect to certain configurations may be combined in various other configurations. Different aspects and elements of the configurations may be combined in a similar manner. Also, technology evolves and, thus, many of the elements are examples and do not limit the scope of the disclosure or claims.

Specific details are given in the description to provide a thorough understanding of exemplary configurations including embodiments. However, configurations may be practiced without these specific details. For example, well-known circuits, processes, algorithms, structures, and techniques have been shown without unnecessary detail in order to avoid obscuring the configurations. This description provides example configurations only, and does not limit the scope, applicability, or configurations of the claims. Rather, the preceding description of the configurations will provide those skilled in the art with an enabling description for implementing described techniques. Various changes may be made in the function and arrangement of elements without departing from the spirit or scope of the disclosure.

Also, configurations may be described as a process which is depicted as a schematic flowchart or block diagram. Although each may describe the operations as a sequential process, many of the operations can be performed in parallel or concurrently. In addition, the order of the operations may be rearranged. A process may have additional steps not included in the figure. Furthermore, examples of the methods may be implemented by hardware, software, firmware, middleware, microcode, hardware description languages, or any combination thereof. When implemented in software, firmware, middleware, or microcode, the program code or code segments to perform the necessary tasks may be stored in a non-transitory computer-readable medium such as a storage medium. Processors may perform the described tasks.

Having described several example configurations, various modifications, alternative constructions, and equivalents may be used without departing from the spirit of the disclosure. For example, the above elements may be components of a larger system, wherein other rules may take precedence over or otherwise modify the application of the technology. Also, a number of steps may be undertaken before, during, or after the above elements are considered. Accordingly, the above description does not bind the scope of the claims.

As used herein and in the appended claims, the singular forms “a”, “an”, and “the” include plural references unless the context clearly dictates otherwise. Thus, for example, reference to “a sensor” includes a plurality of sensors, and reference to “the processor” includes reference to one or more processors and equivalents thereof known to those skilled in the art, and so forth. Ordinals such as “first sensor” and “second sensor” only mean they may be different. There is no specific sequence unless the context clearly dictates otherwise. Thus, for example, “first sensor” can be described as “second sensor”, and vice versa.

Also, the words “comprise”, “comprising”, “contains”, “containing”, “include”, “including”, and “includes”, when used in this specification and in the following claims, are intended to specify the presence of stated features, integers, components, or steps, but they do not preclude the presence or addition of one or more other features, integers, components, steps, acts, or groups.

What is claimed is:

1. An EV charging station comprises:
a housing, at least one storage battery, a substantially flat panel, an array of photovoltaic modules and a control unit; and, wherein
the housing is configured to enclose the at least one storage battery and is configured to receive electric power from a power grid;
the substantially flat panel is attached to the housing;
the array of photovoltaic modules are affixed to the flat panel and are configured to convert solar energy from sun light into electrical energy, and transfer the electrical energy from the array of photovoltaic modules to the storage battery in the housing; and
the control unit is configured to:
receive a first signal indicating the power grid is overloaded and not available to the EV charging station;
in response to receiving the first signal, determining whether the storage battery is charged; and
in response to the determination that the storage battery is charged and to the first signal having been received, switching the EV charging station to a charge mode where the storage battery is used, instead of the power grid, to charge an EV.

2. The EV charging station according to claim 1, wherein the storage battery is configured to be charged by the power grid.

3. The EV charging station according to claim 1, wherein the EV charging station further comprises a battery management system configured to monitor one or more of the storage batteries.

4. The EV charging station according to claim 1, wherein the control unit is further configured to:
receive a second signal indicating a charge percentage of the storage battery;
receive a light intensity value of the sun light; and
in response to receiving the second signal and the light intensity value, determining energy source to charge the storage battery, wherein the energy source is at least one of the power grid or the sun light.

5. The EV charging station according to claim 1, wherein the control unit is further configured to:
in response to receiving the first signal, determining whether a charge percentage of the storage battery is beyond a preset value; and
in response to the determination that the charge percentage of the storage battery is beyond the preset value and to the first signal having been received, switching the EV charging station to the charge mode where the storage battery is used, instead of the power grid, to charge the EV.

6. The EV charging station according to claim 1, wherein the array of photovoltaic modules is configured to produce an alternating current output.

7. The EV charging station according to claim 6, further comprises a first inverter electrically interconnecting the array of photovoltaic modules with the storage battery to convert alternating current from the array of photovoltaic modules into direct current at the storage battery.

8. The EV charging station according to claim 1, wherein the array of photovoltaic modules is configured to produce a direct current output.

9. The EV charging station according to claim 1, further comprises a second inverter electrically interconnecting the storage battery with the EV to convert direct current from the storage battery into alternating current at the EV.

10. An EV charging method comprises:
receiving, by a housing in an EV charging station, electric power from a power grid;
converting, by an array of photovoltaic modules affixed to a substantially flat panel attached to the housing, solar energy from sun light into electrical energy;
transferring, by the array of photovoltaic modules, the electrical energy to a storage battery in the housing;
receiving, by a control unit in the housing, a first signal indicating the power grid is overloaded and not available to the EV charging station;
in response to receiving the first signal, determining whether the storage battery is charged; and
in response to the determination that the storage battery is charged and to the first signal having been received, switching the EV charging station to a charge mode where the storage battery is used, instead of the power grid, to charge an EV.

11. The EV charging method according to claim 10, wherein the storage battery is configured to be charged by the power grid.

12. The EV charging method according to claim 10, wherein the EV charging station further comprises a battery management system configured to monitor one or more of the storage batteries.

13. The EV charging method according to claim 10, further comprises:
receiving a second signal indicating a charge percentage of the storage battery;
receiving a light intensity value of the sun light; and
in response to receiving the second signal and the light intensity value, determining energy source to charge the storage battery, wherein the energy source is at least one of the power grid or the sun light.

14. The EV charging method according to claim 10, further comprises:
in response to receiving the first signal, determining whether a charge percentage of the storage battery is beyond a preset value; and
in response to the determination that the charge percentage of the storage battery is beyond the preset value and to the first signal having been received, switching the EV charging station to the charge mode where the storage battery is used, instead of the power grid, to charge the EV.

15. The EV charging method according to claim 10, wherein the array of photovoltaic modules is configured to produce an alternating current output.

16. The EV charging method according to claim 15, wherein the EV charging station further comprises a first inverter electrically interconnecting the array of photovoltaic modules with the storage battery to convert alternating current from the array of photovoltaic modules into direct current at the storage battery.

17. The EV charging method according to claim 10, wherein the array of photovoltaic modules is configured to produce a direct current output.

18. The EV charging method according to claim 10, wherein the EV charging station further comprises a second inverter electrically interconnecting the storage battery with the EV to convert direct current from the storage battery into alternating current at the EV.
